(19) United States
(12) Patent Application Publication
(10) Pub. No.: US 2008/0126430 A1
(43) Pub. Date: May 29, 2008

(54) INTERMEDIARY DOCUMENT FOR CRITICAL CHANGE CONTROL

(76) Inventors: Andrew J. Garrett, Abbots Langley (GB); Scott D. Hicks, Underhill Center, VT (US); James A. Martin, Endicott, NY (US); Jeffrey E. Prince, Bloomfield Hills, MI (US)

Correspondence Address: HOFFMAN, WARNICK & D'ALESSANDRO LLC, 75 STATE ST, 14TH FLOOR, ALBANY, NY, 12207, US

(21) Appl. No.: 11/563,841

(22) Filed: Nov. 28, 2006

(51) Int. Cl. G06F 17/00; G06F 3/048

(52) U.S. Cl. 707/200; 715/764; 707/E17.001

(57) ABSTRACT

A solution for improving control of changes made to data, and more particularly, to a method, system, and computer program product for providing an intermediary document for critical change control is provided. A method may include receiving a proposed change to a field in a dataset, wherein the field is critical; and updating an intermediary document that indicates the proposed change to the field, wherein the proposed change is not processable to the dataset until the intermediary document is updated. In an embodiment, the intermediary document is displayed on a graphical user interface (GUI).

### FIELD OF THE INVENTION

The invention relates generally to improving control of changes made to data elements, and more particularly, to a method, system, and computer program product for providing an intermediary document for critical change control.

### BACKGROUND OF THE INVENTION

Projects that entail changing and/or updating data often entail the changing of data elements. Certainly, the change of a particular data element, or field, may be a simple affair, whereas the change has no, or a negligible, effect on the project and the project's aspects. However, for certain other data elements, their change may be highly influential to other aspects of the project including: schedule, costs, budget, resources, contracts, other projects, other sites, and/or the like. Thus, changes to these data elements, or fields, may be critical to the project and the project's aspects.

As such, any proposed changes to these critical data elements is highly sensitive. If one of these critical data elements is changed incorrectly, the resultant changes to various aspects of the project often prove catastrophic. The change that was incorrect may be because no change to the data element should have even occurred; a change should have occurred, but the wrong change occurred (e.g., mistaken value); and/or the like. For these and other reasons, changes to critical data elements may need to be highlighted or flagged.

In any event, current controls for potential changes to critical data elements are inadequate. In view of the foregoing, a need exists to overcome one or more of the deficiencies in the related art.

### BRIEF SUMMARY OF THE INVENTION

The present invention includes a solution for improving control of changes made to data, and more particularly, to a method, system, and computer program product for providing an intermediary document for critical change control.

A first aspect of the present invention is directed to a method of controlling changes to data, the method comprising: receiving a proposed change to a field in a dataset, wherein the field is critical; and updating an intermediary document that indicates the proposed change to the field, wherein the proposed change is not processable to the dataset until the intermediary document is updated.

A second aspect of the present invention is directed to a system for controlling changes to data, the system comprising: a system for receiving a proposed change to a field in a dataset, wherein the field is critical; and a system for updating an intermediary document that indicates the proposed change to the field, wherein the proposed change is not processable to the dataset until the intermediary document is updated.

A third aspect of the present invention is directed to a computer program stored on a computer-readable medium, which when executed, enables a computer system to control changes to data, the computer program comprising program code for enabling the computer system to: receive a proposed change to a field in a dataset, wherein the field is critical; and update an intermediary document that indicates the proposed change to the field, wherein the proposed change is not processable to the dataset until the intermediary document is updated.

A fourth aspect of the present invention is directed to a method for deploying a system for controlling changes to data, comprising: providing a computer infrastructure being operable to: receive a proposed change to a field in a dataset, wherein the field is critical; and update an intermediary document that indicates the proposed change to the field, wherein the proposed change is not processable to the dataset until the intermediary document is updated.

A fifth aspect of the invention provides computer software embodied in a propagated signal for controlling changes to data, the computer software comprising instructions to cause a computer system to perform the following: receive a proposed change to a field in a dataset, wherein the field is critical; and update an intermediary document that indicates the proposed change to the field, wherein the proposed change is not processable to the dataset until the intermediary document is updated.

A sixth aspect of the present invention is directed to a business method for controlling changes to data, the business method comprising: managing a computer system that performs the process described herein; and receiving payment based on the managing.

The illustrative aspects of the present invention are designed to solve the problems herein described and other problems not discussed.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 depicts a schematic flow diagram of an illustrative process in accordance with an embodiment of the present invention.

FIG. 2A depicts an intermediary document for critical data change control in accordance with an embodiment of the present invention.

FIG. 2B depicts an intermediary document for critical data change control in accordance with another embodiment of the present invention.

FIG. 3 depicts an intermediary document for critical data change control in accordance with an embodiment of the present invention.

FIG. 4 depicts a field definition view in accordance with an embodiment of the present invention.

FIG. 5 depicts a field definition document view in accordance with an embodiment of the present invention.

FIG. 6 depicts a site document view prior to a processed change in accordance with an embodiment of the present invention.

FIG. 7 depicts the view in FIG. 3 upon approval of the field value change in accordance with an embodiment of the present invention.

FIG. 8 depicts the view in FIG. 6 after a processed change in accordance with an embodiment of the present invention.

FIG. 9 depicts the view in FIG. 3 after a processed change in accordance with an embodiment of the present invention.

FIG. 10 depicts the intermediary document for critical data change control from FIG. 2B upon processing of a critical data change in accordance with an embodiment of the present invention.

FIG. 11 depicts an illustrative system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Aspects of the present invention include improvements in controlling changes to data, particularly critical data, by employing an intermediary document.

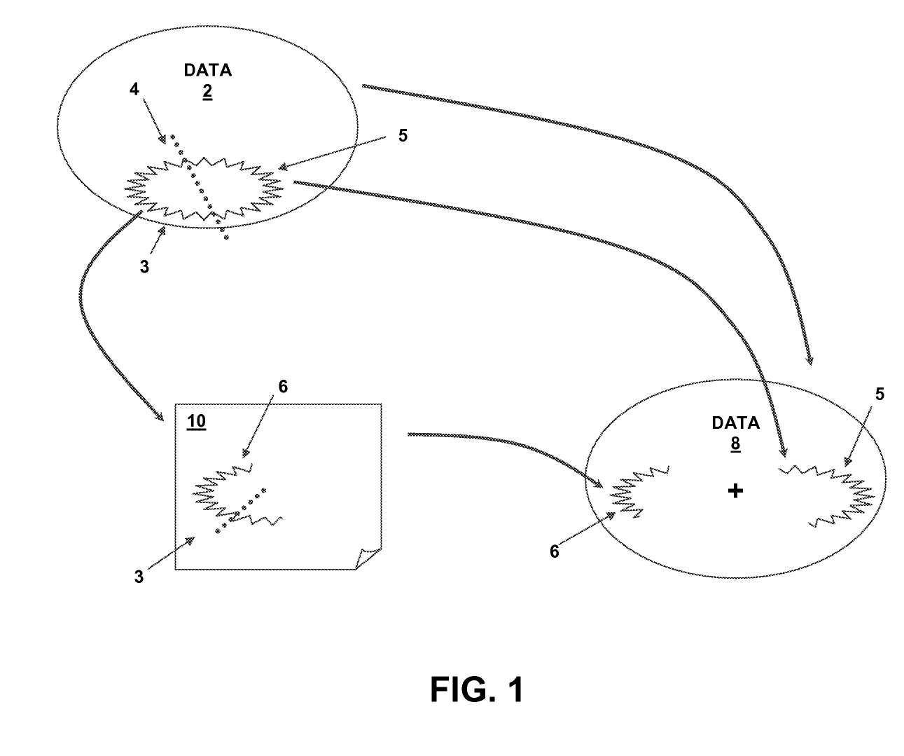

A schematic flow diagram of an illustrative process in accordance with embodiment(s) of the present invention is depicted in FIG. 1.

FIG. 1 includes a first set of data 2 that may include a set (i.e., one or more) of proposed changes 4 that are in need of being processed into a second set of data 8. The set of proposed changes 4 may range in size from a single data field to near infinite in size, and/or be the entire set of data 2. In any event, a portion of the set of proposed changes 4 is determined to be critical, as depicted by 3. Contrastingly, a portion of the proposed changes set 4 is determined to be non-critical, as depicted by 5. With both the critical proposed changes 3 and the non-critical proposed changes 5, either may range in size from the null set (i.e., zero data fields) to the entire proposed changes set 4. For example, all of the proposed changes set 4 may be critical 3, when there are no data elements that are non-critical 5. Conversely, all of the proposed changes set 4 may be non-critical 5, when there are no data elements that are critical 3.

In any event, any non-critical proposed data 5 may be processed automatically, in real-time, and/or the like, so that the non-critical proposed data 5 is processed into the second set of data 8, as shown in FIG. 1, without consideration by an intermediate document 10.

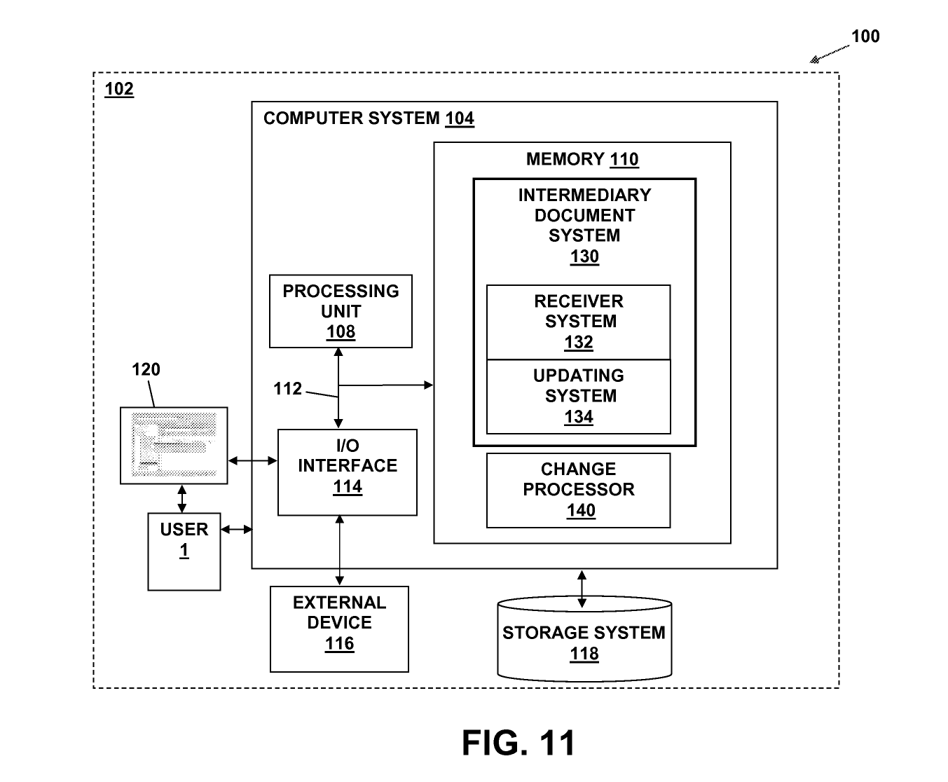

Thus, the intermediate document 10 indicates the critical proposed changes to data 3, in accordance with aspects of the present invention. So, none of the critical proposed changed data 3 may be processed into the second dataset 8 without first updating the intermediate document 10. In this manner, improved change control of data is ultimately obtained. The term updating includes creating, changing, modifying, editing, adding, and/or the like. As shown in FIG. 1, the critical proposed data changes 3 are indicated on the intermediate document 10. A user 1 (FIG. 11) may then review the critical proposed data changes 3 and determine that a portion of the critical proposed data changes 3 should not be processed into the second set of data 8. The processed portion of critical proposed data changes 3 is indicated by a 6. Clearly, the processed critical data changes 6 may range in size from none (i.e., zero data fields) to the entire proposed critical data changes 3 that are indicated on the intermediary document 10. Ultimately, the processed second dataset 8 may include a portion of the first data set 2 that did not entail any changes (if any); the non-critical data changes 5 (if any); and, the approved portion 6 of the proposed critical data changes 3 (if any).

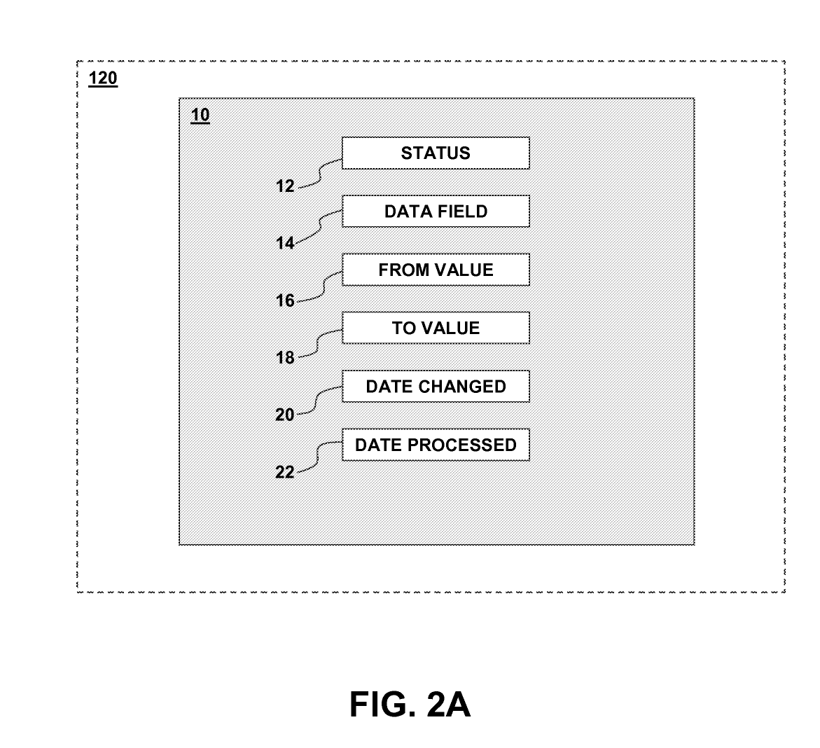

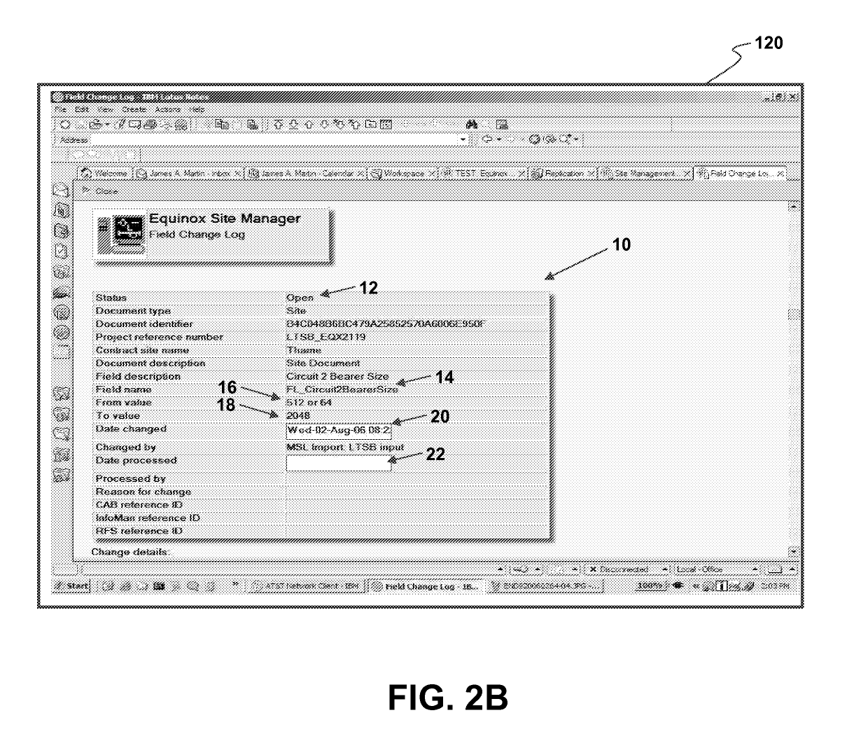

FIGS. 2A through FIG. 11 show illustrative embodiments for controlling changes to a subset of data by employing the intermediary document 10. FIG. 2A, for example, shows an embodiment of the intermediary document 10 depicted on a graphical user interface (GUI) 120. Although the intermediary document 10 is shown in several embodiments on the GUI 120, the invention is not limited to use of the GUI 120. Clearly, other embodiments are included within the scope of aspects of the invention including, for example, providing the intermediary document 10 as a printed report, an audio communication, and/or some combination of communication methodologies.

In any event, as FIG. 2A shows, the intermediary document 10 may include various indicators that allow the user 1 (FIG. 11) to review, verify, approve, process, edit, change, and/or conduct other actions to the proposed change to critical data 3 (FIG. 1) prior to processing the change into the second set of data 8 (FIG. 1). Indicators may include a status 12 (e.g., open, processed, rejected, etc.); a data field 14 (e.g., field name, field description, etc.); a from value 16; a to value 18; a date changed 20; and/or a date processed 22.

The status 12 indicates a specific condition, or status, for the particular proposed change to the data field 14. The data field 14 indicates which particular data field is being proposed for change. The from value 16 indicates the value, or former value, of the data field 14 that is being proposed for change. Similarly, the to value 18 is the value of the data field 14 after the change. The date changed 20 indicates the date and/or time that the data field 14 was changed, or more accurately, proposed for change. The date processed 22 indicates the date and/or time that the to value 18 was processed (e.g., approved), if applicable.

While FIG. 2A shows a fairly generic embodiment of an intermediary document 10, in accordance with aspects of the present invention, FIGS. 2B through 10 depict embodiments employing Equinox Programme, manufactured by International Business Machines Corporation. These views are illustrative only and are not limiting. Note that throughout these various figures, for illustrative purposes a single example of a change to a single field will be discussed. Referring to FIG. 2B, the illustrative data field 14 that is being changed is “FL_Circuit2BearerSize” having a description “Circuit 2 Bearer Size”. The from value 16 is “512 or 64”, while the to value 18 is “2048”. That is, in the example shown, the data field 14 “FL_Circuit2BearerSize” is critical. The value of the data field 14 is being changed from a value of “512 or 64” to a value of “2048”.

Thus, FIG. 2B depicts a GUI 120 that includes intermediary document 10, in this case a field value change log document. The GUI 120 allows the user 1 to view various aspects of information including status 12 (i.e., “open”); field name 14 (i.e., “FL_Circuit2BearerSize”); from value 16 (i.e., “512 or 64”); to value 18 (i.e., “2048”); date changed 20 (i.e., Wednesday, Aug. 2, 2006); and, date processed 22 (i.e., blank). In FIG. 2B, because the status 12 is “open” the proposed change from “512 or 64” to “2048” has not been processed. Thus, date processed 22 remains blank. Other aspects related to the field name change may be shown including, for example, document type, document identifier, project reference number, document description, and others.

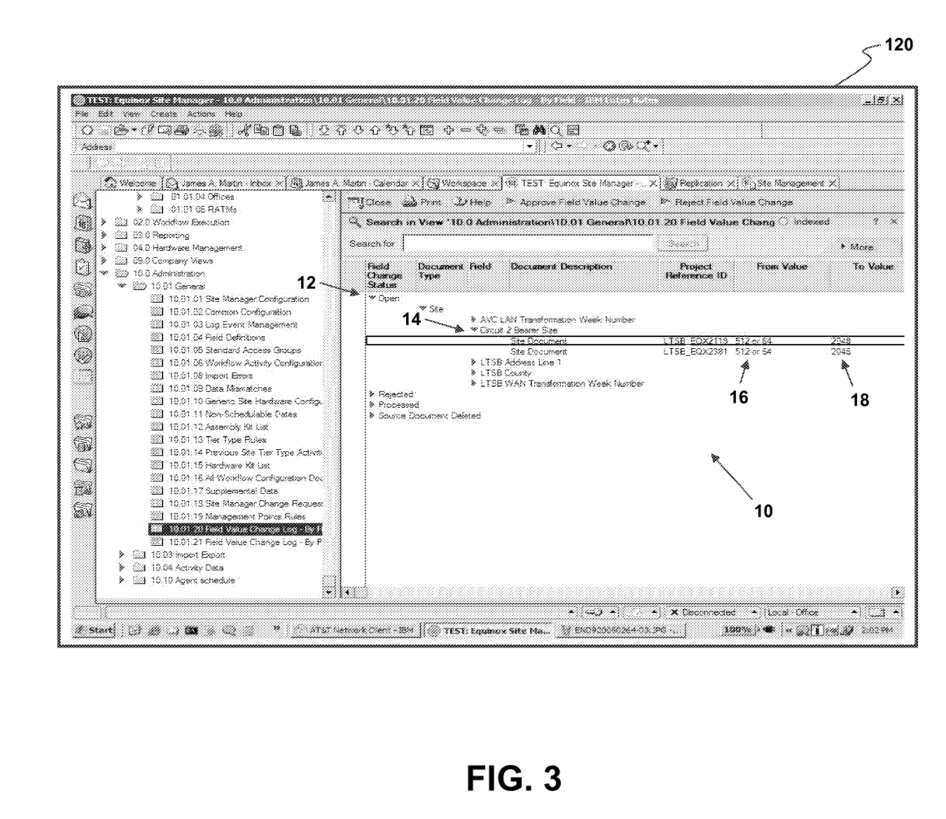

FIG. 3 depicts a GUI 120 that includes an intermediary document 10. The GUI 120 allows the user 1 to view various aspects of information including status 12 (e.g., “open”) and any data that has a particular value for status 12. For example, the user 1 can view what values that data having field name 14 (e.g., “Circuit 2 Bearer Size”) has. Circuit 2 Bearer Size, for example, has the following values: a from value 16 of “512 or 64”; a to value 18 of “2048”; and, a status 12 value that is “open”. The proposed change from “512 or 64” (i.e., from value 16) to “2048” (i.e., to value 18) has not been processed. Other aspects related to the change may be shown including, for example, document type, field, project reference ID, document description, and others.

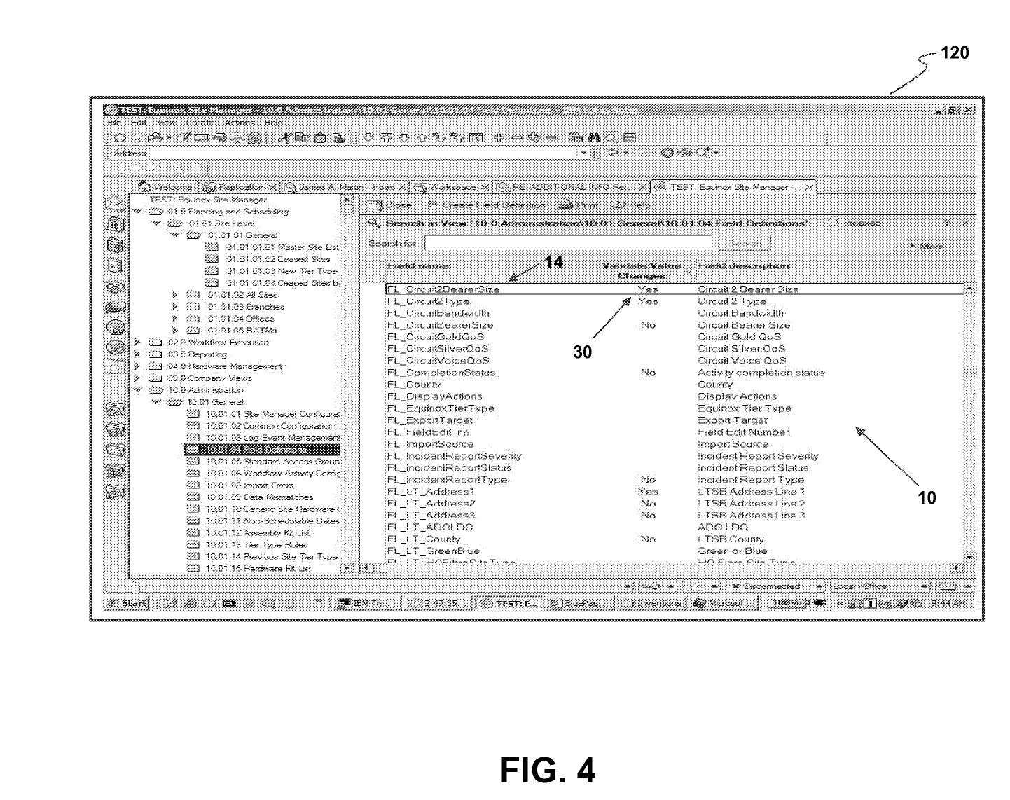

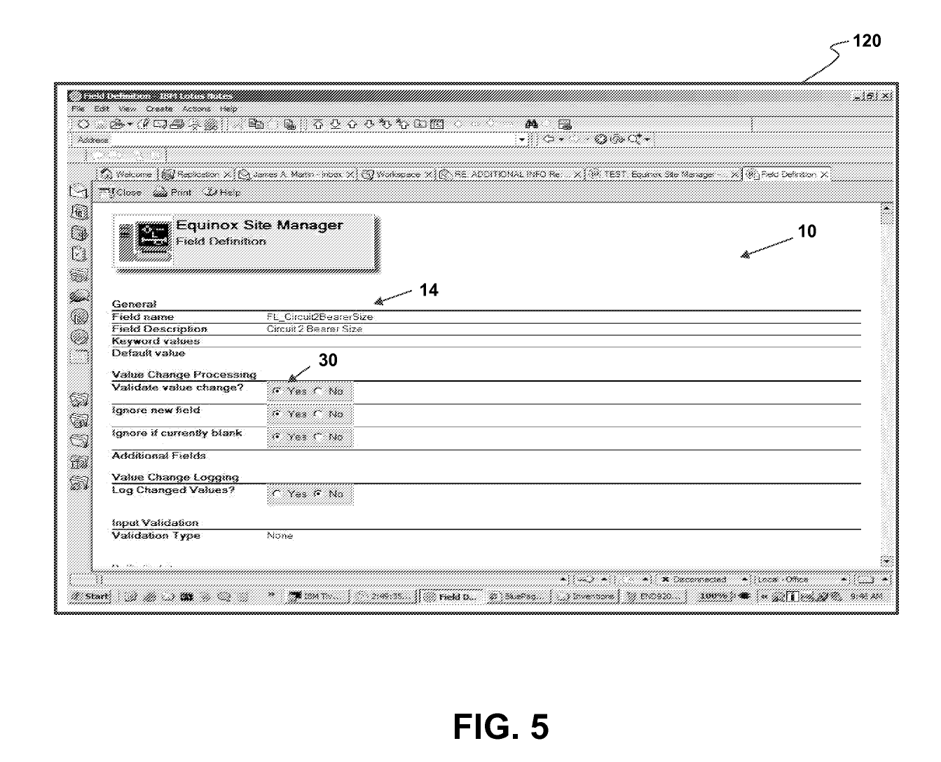

FIGS. 4 and 5 depict GUIs 120 that include intermediary document 10, in this case a field definition view and field definition document, respectively. The GUI 120 in the field definition view (i.e., FIG. 4) allows the user 1 to view what data fields, if any, are critical. A validate value changes field 30 indicates whether or not a particular data field name 14 has been deemed critical, and, therefore, is indicated on the intermediary document 10. For example, all data field names 14 in FIG. 4 that have a value “Yes” under the validate value changes field 30 will be indicated on an applicable intermediary document 10. As shown, critical data changes dataset 6 (FIG. 1) includes the “FL_Circuit2BearerSize”. Additionally, the field definition document in FIG. 5 allows the user 1 to change the validate value changes field 30 value between “Yes” (e.g., critical data) and “No” (e.g., non-critical data). Clearly, the GUI 120 shown in FIG. 5 may have security aspects so that a limited group of users may be able to access and/or activate.

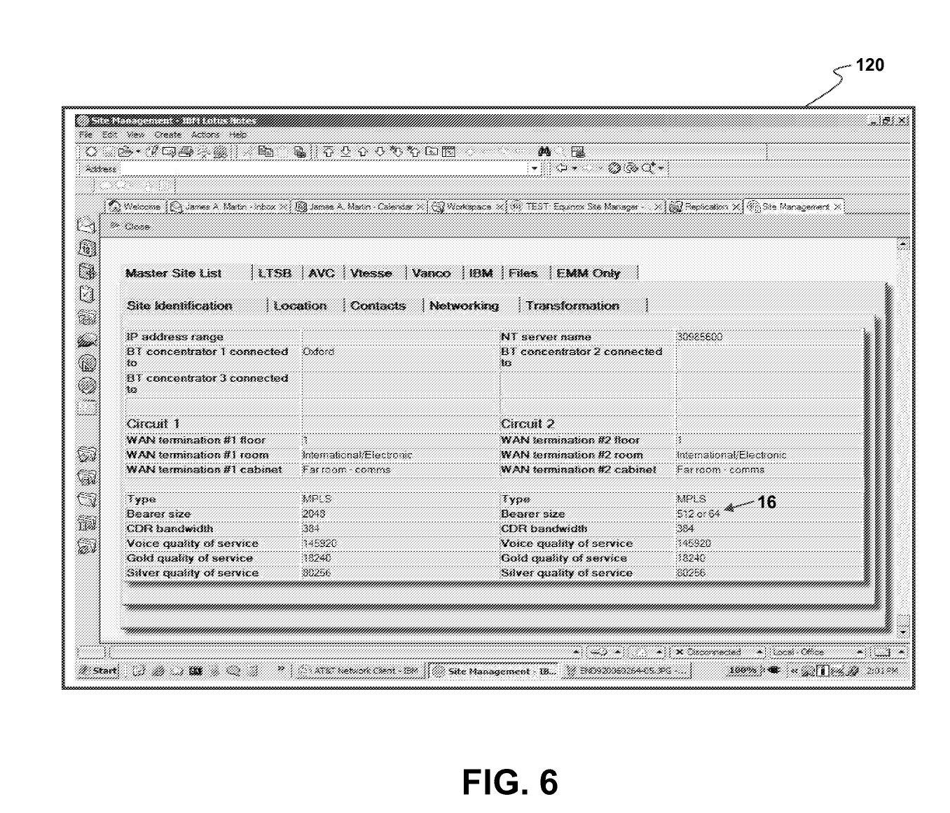

FIG. 6 depicts a GUI 120 that includes information, in this case a site document view before processing of a change. The GUI 120 allows the user 1 to view various aspects of information of data fields. The view indicates that the field 14 Circuit2BearerSize has a value of “512 or 64” (i.e., from value 16).

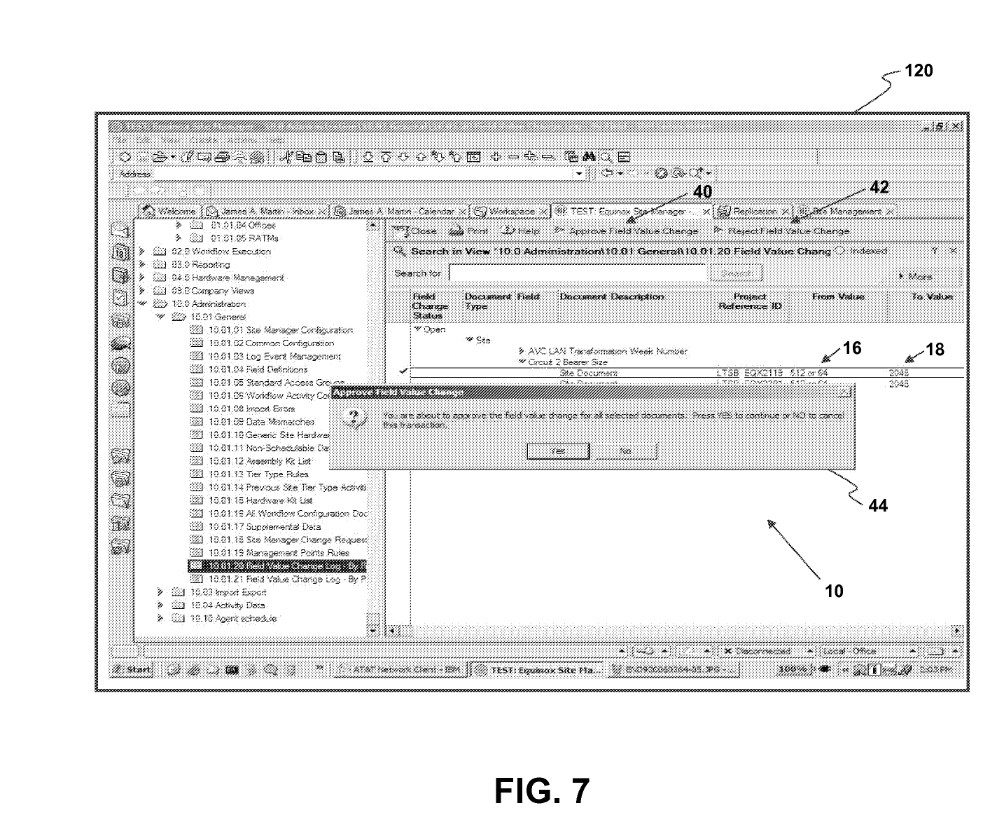

FIG. 7 depicts the GUI 120 shown in FIG. 3 (i.e., field value change log), undergoing approval and/or processing of the proposed change to the data by the user 1. The GUI 120 includes an approve field value change indicator 40 and a reject field value change 42. By clicking, for example, on the approve field value change indicator 40 an indicator box 44 appears so that the user 1 is queried to verify that the proposed change to the value of the data is acceptable (i.e, change of field value from from value 16 to to value 18). Upon clicking “yes” in the indicator box 44, the value of field 14 Circuit2BearerSize will change from “512 or 64” to “2048”.

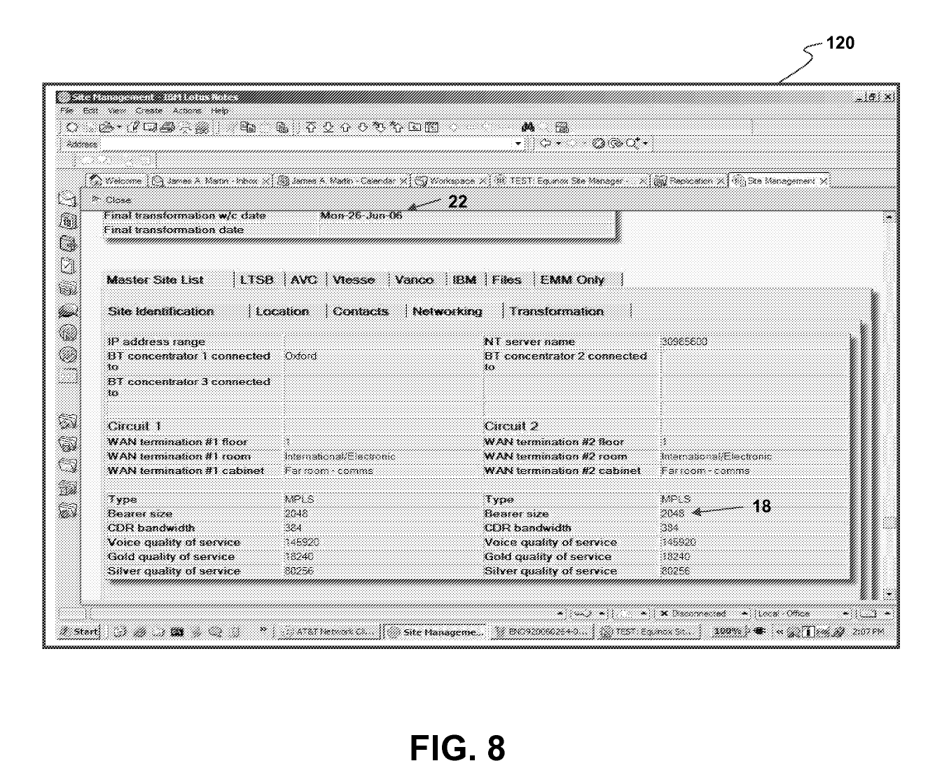

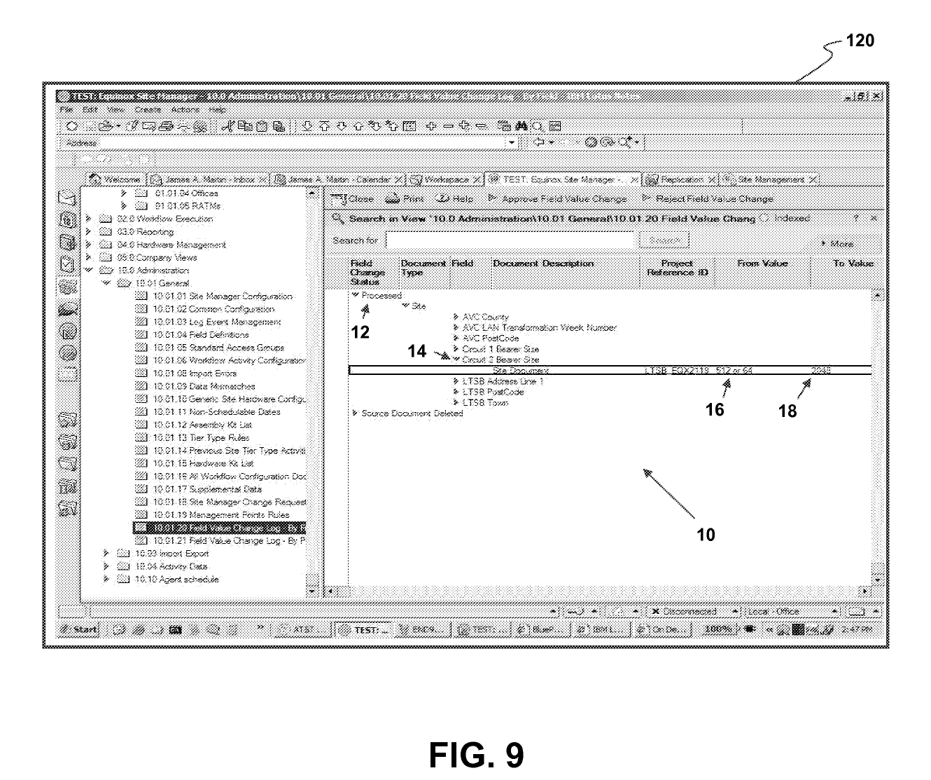

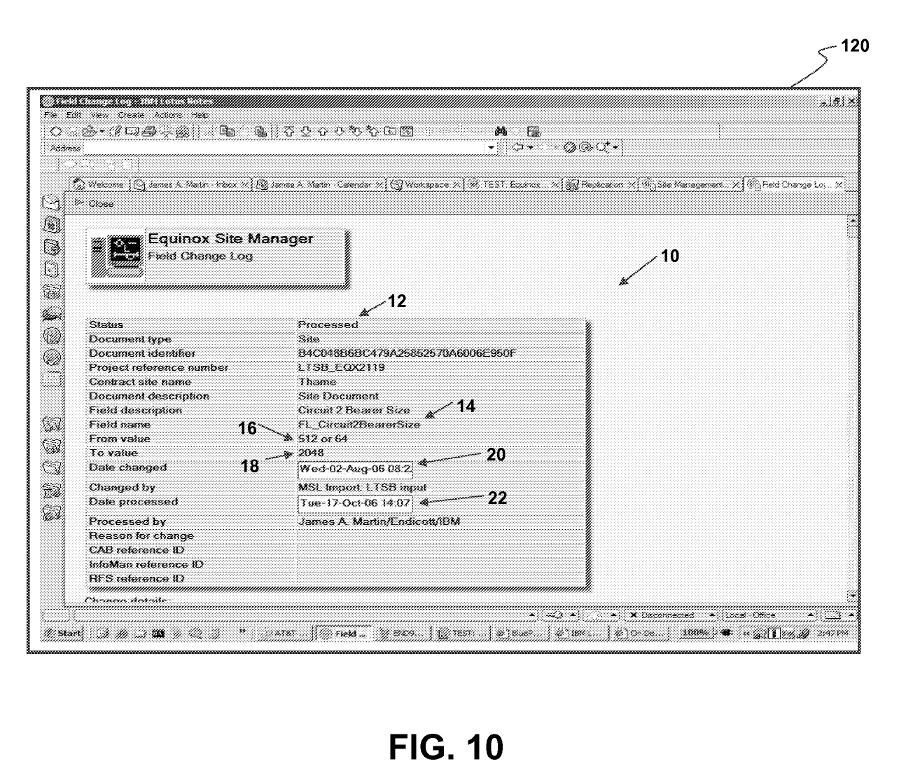

FIG. 8 depicts the GUI 120 in FIG. 6, after the change to the data is approved. As shown, the bearer size value 18 is now shown as “2048”. Similarly, FIGS. 9 and 10 indicate views of GUIs 120 shown in FIGS. 3 and 2B, respectively, also indicating the applicable change to the value of particular data (e.g., bearer size).

Various additional attributes are available under aspects of the present invention. For example, once the intermediary document 10 is updated, the proposed changes 6 may be approved, thereby allowing subsequent processing of the proposed changes 6 to the dataset 8. Additionally, a request for service (RFS) based on the proposed changes 6 may be processed.

FIG. 11 depicts an illustrative system 100 in accordance with embodiment(s) of the present invention. The system 100 includes a computer infrastructure 102 that can perform the process described herein. The computer infrastructure 102 is shown including a computer system 104.

The computer system 104 is shown including a processing unit 108, a memory 110, at least one input/output (I/O) interface 114, and a bus 112. Further, the computer system 104 is shown in communication with at least one external device 116 and a storage system 118. In general, the processing unit 108 executes computer program code that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., GUI 120) that enables a user 1 to interact with the computer system 104 or any device that enables the computer system 104 to communicate with one or more other computer systems.

In accordance with an embodiment of the present invention, the program code stored in the memory 110 comprises an intermediary document system 130 for controlling changes to data. Provided as part of the intermediary document system 130 is a receiver system 132 for receiving proposed changes to a field in a dataset, wherein the field may be critical and an updating system 134 for updating the intermediary document 10 that indicates the proposed change to the field. In this manner, any proposed change(s) is not processable to the dataset until the intermediary document 10 is updated. Also provided may be a change processor 140 that processes any critical field changes that have been created by the updating system 134. The operation carried out by each of these systems is described in greater detail herein.

The computer system 104 can comprise any general purpose computing article of manufacture capable of executing computer program code installed thereon (e.g., a personal computer, server, handheld device, etc.). However, it is understood that the computer system 104 and its various elements is only representative of various possible computer systems that may perform the processes of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the processes of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 11 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in one embodiment, the invention provides a computer-readable medium that includes computer program code to enable a computer infrastructure to carry out and/or implement the process of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process of the invention on a subscription, advertising, and/or fee basis. A service provider can create, maintain, support, etc., a computer infrastructure, such as the computer infrastructure 102, that performs the process of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the process of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method of controlling changes to data, the method comprising:
receiving a proposed change to a field in a dataset, wherein the field is critical; and
updating an intermediary document that indicates the proposed change to the field, wherein the proposed change is not processable to the dataset until the intermediary document is updated.

2. The method of claim 1, wherein the intermediary document includes a changes log.

3. The method of claim 1, wherein the intermediary document further indicates at least one field of the proposed change selected from a group consisting of: a data field, a from value, a to value, a date changed, and a date processed.

4. The method of claim 1, further comprising:
providing the intermediary document for display on a graphical user interface (GUI).

5. The method of claim 4, wherein the GUI displays a plurality of proposed changes.

6. The method of claim 1, further comprising:
receiving an approval of the proposed change; and
processing the proposed change to the dataset.

7. The method of claim 1, further comprising:
providing a request for service (RFS) based on the proposed change.

8. A system for controlling changes to data, the system comprising:
a system for receiving a proposed change to a field in a dataset, wherein the field is critical; and
a system for updating an intermediary document that indicates the proposed change to the field, wherein the proposed change is not processable to the dataset until the intermediary document is updated.

9. The system of claim 8, wherein the intermediary document includes a changes log.

10. The system of claim 8, wherein the intermediary document further indicates at least one field of the proposed change selected from a group consisting of: a data field, a from value, a to value, a date changed, and a date processed.

11. The system of claim 8, further comprising:
a system for providing the intermediary document for display on a graphical user interface (GUI).

12. The system of claim 11, wherein the GUI displays a plurality of proposed changes.

13. The system of claim 8, further comprising:
a system for receiving an approval of the proposed change; and
a system for processing the proposed change to the dataset.

14. The system of claim 8, further comprising:
a system for providing a request for service (RFS) based on the proposed change.

15. A computer program stored on a computer-readable medium, which when executed, enables a computer system to control changes to data, the computer program comprising program code for enabling the computer system to:
receive a proposed change to a field in a dataset, wherein the field is critical; and
update an intermediary document that indicates the proposed change to the, wherein the proposed change is not processable to the dataset until the intermediary document is updated.

16. The computer program of claim 15, wherein the intermediary document further indicates at least one field of the proposed change selected from a group consisting of: a data field, a from value, a to value, a date changed, and a date processed.

17. The computer program of claim 15, further comprising program code for enabling the computer system to:
provide the intermediary document for display on a graphical user interface (GUI).

18. The computer program of claim 15, further comprising program code for enabling the computer system to:
receive an approval of the proposed change; and
process the proposed change to the dataset.

19. The computer program of claim 15, further comprising program code for enabling the computer system to:
provide a request for service (RFS) based on the proposed change.

20. A method for deploying a system for controlling changes to data, comprising:
providing a computer infrastructure being operable to:
receive a proposed change to a field in a dataset, wherein the field is critical; and
update an intermediary document that indicates the proposed change to the field, wherein the proposed change is not processable to the dataset until the intermediary document is updated.
